(19) United States
(12) Patent Application Publication
(10) Pub. No.: US 2005/0033769 A1
(43) Pub. Date: Feb. 10, 2005

(54) File processing apparatus, file processing method, and file processing program product

(75) Inventor: Eiji Mifune, Osaka (JP)

Correspondence Address: CASELLA & HESPOS, 274 MADISON AVENUE, NEW YORK, NY, 10016, US

(73) Assignee: KYOCERA MITA CORPORATION, Osaka (JP)

(21) Appl. No.: 10/637,794

(22) Filed: Aug. 8, 2003

(51) Int. Cl. G06F 7/00

(52) U.S. Cl. 707/104.1

(57) ABSTRACT

A file processing includes reading a file recorded on a record medium, generating an indexed image on the basis of the file, displaying the generated indexed image, and processing a file by way of the displayed indexed-image. The processing includes splitting of a file, combining of files, deleting of a file, replacing of pages in a file. The user can execute file processing on the basis of the indexed-images on a display screen easily without causing hang-up or malfunction.

### BACKGROUND OF THE INVENTION

This invention relates to a file processing apparatus, file processing method, and file processing program product which process computerized files.

Conventionally, as a document format capable of making a display without relying on a specific platform, for example, a PDF (Portable Document Format) used for documentation management is well known. Such a PDF-type file (hereinafter, referred to as PDF file) is widely used because it is easy to handle. In fact, this is said to be a standard format for electronic documents at present. An application for image editing (e.g., Acrobat PDF or the like) is used to process PDF files. Such processing includes combining several PDF files, deleting each image data included in a PDF file, rearranging the order of page numbers of an image data included in a PDF file, or splitting a file containing several pages of image data into each page and turning the file into several files.

However, in the case of processing a file using the image-editing application such as Acrobat PDF, it is necessary to specify an image data to be processed. Specifically, it is required to enter numerical values according to where the image data to be deleted is in a PDF file or which page it is, which page to be exchanged for which page in the file, or the like. Similarly, in the case of splitting a PDF file including several pages of image data into each page, it is necessary to enter numerical values according to which page the image data to be split is in a PDF file, or the like. This has required the user to be aware of the page order of an image data or the like in a PDF file, preventing the user from specifying the image data the user wants to process.

### SUMMARY OF THE INVENTION

It is an object of the present invention to provide a file processing apparatus, a file processing method, and a file processing program product which are free from the problems residing in the prior art.

It is another object of the present invention to provide a file processing apparatus, a file processing method, and a file processing program product which can specify an image data to be processed in a file and process the file by easy operations.

According to an aspect of the present invention, files are read from a record medium storing the files. An indexed image of the read file is generated, and is displayed on a display screen. The file is processed by way of the indexed image on the display screen.

These and other objects, features, aspects, and advantages of the present invention will become more apparent from the following detailed description of the preferred embodiments/examples with reference to the accompanying drawings.

### BRIEF DESCRIPTION OF THE DRAWINGS

FIG. 1 is a block diagram showing a rough configuration of a personal computer which executes a file processing program in accordance with an embodiment of the invention;

FIG. 2 is a block diagram showing main functions of the personal computer which is executed by the file processing program;

FIG. 3 is a flowchart showing a process for stacking PDF files in accordance with the file processing program;

FIG. 4A is an illustration showing a rough configuration of each PDF file before the stacking process;

FIG. 4B is an illustration showing a rough configuration of a PDF file after the stacking process;

FIGS. 5A and 5B are illustrations showing a display screen while a file to be stacked is being selected;

FIG. 5C is an illustration showing the display of indexed images on the display screen after the stacking process;

FIG. 6 is a flowchart showing a process for deleting an image data in a PDF file in accordance with the file processing program;

FIG. 7A is an illustration showing a rough configuration of a PDF file before the deleting process;

FIG. 7B is an illustration showing a rough configuration of a PDF file after the deleting process;

FIG. 8A is an illustration showing a display screen when an image data to be deleted is selected;

FIG. 8B is an illustration showing a display on the display screen after the deleting process;

FIG. 9 is a flowchart showing a process for changing the page order of an image data in a PDF file in accordance with the file processing program;

FIG. 10A is an illustration showing a rough configuration of a PDF file before the page-order changing process;

FIG. 10B is an illustration showing a rough configuration of a PDF file after the page-order changing process;

FIGS. 11A and 11B are illustrations showing a display on a display screen while an image data to be exchanged is being selected;

FIG. 11C is an illustration showing a display screen after the page-order changing process;

FIG. 12 is a flowchart showing a process for splitting a PDF file in accordance with the file processing program;

FIG. 13 is an illustration showing a rough configuration of a PDF file before and after the splitting process is executed;

FIG. 14 is an illustration showing a display screen which gives an instruction that the splitting process cannot be executed;

FIG. 15 is an illustration showing a display screen which gives a message about the storage capacity required for the splitting process and to confirm that the splitting process will be executed;

FIG. 16 is an illustration showing a display screen when a file to be split is selected;

FIG. 17 is a flowchart showing a second process for splitting a PDF file in accordance with the file processing program;

FIG. 18 is an illustration showing a rough configuration of a PDF file before and after the splitting process is executed;

FIG. 19 is an illustration showing a display screen when files to be split is selected; and

FIG. 20 is a flowchart showing a process for displaying a page view.

### DETAILED DESCRIPTION OF THE PREFERRED EMBODIMENTS OF THE INVENTION

A preferred embodiment of the invention will be described with reference to the attached drawings. In this embodiment, a file to be processed will be described using a PDF file as an example.

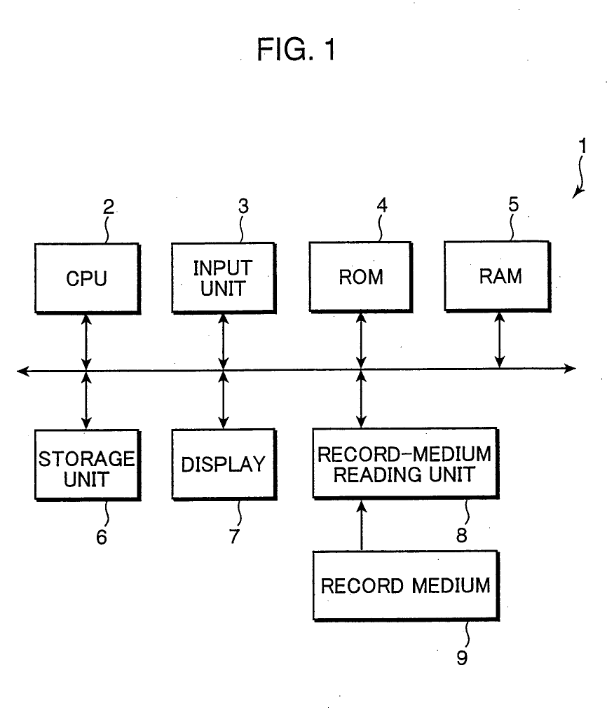

Referring to FIG. 1, a personal computer 1 includes a CPU 2 which governs the operation and control of the whole apparatus. An input unit 3, a ROM 4, a RAM 5, a storage unit 6, a display 7 and a record-medium reading unit 8 are connected to the CPU 2 via an internal bus. Each kind of data is inputted and outputted between each unit via the internal bus under the control of the CPU 2 to execute each kind of processing.

The input unit 3 is configured by a keyboard, a mouse and the like. The user enters an operational command and the like in the input unit 3. A system program for the operation and control of the whole apparatus and the like are stored in the ROM 4. The storage unit 6 is configured by a hard disk drive and the like. The file processing program is stored in the storage unit 6. The CPU 2 reads the program and the like from the storage unit 6 and executes its processing to control the operation of each block. The RAM 5 is used as a work area of the CPU 2. The display 7 is configured by a CRT, a liquid-crystal display unit or the like. The display 7 displays each kind of images in the control of the CPU 2. Herein, such a configuration of the personal computer 1 is merely one example.

The program mentioned above may also be read from a record medium 9 such as a CD-ROM or FD, using the record-medium reading unit 8 configured by a disk drive and the like, and then recorded on the storage unit 6. In the case where the personal computer 1 is connected to another computer or the like via a network, the program may also be downloaded from such a computer or the like through the network.

Specifically, in general, the routines executed to implement the embodiment of the invention, whether implemented as part of an operating system or a specific application, component, program, object, module or sequence of instructions will be referred to as “programs”. The program comprises one or more instructions that are resident at various times in various memory and storage devices in a computer, and that cause the computer to perform the steps necessary to execute steps or elements embodying the various aspects of the invention.

The embodiment of the invention has and will be described in the context of functioning the computer and computer system. However, those skilled in the art will appreciate that various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, optical disks (e.g., CD-ROM's, DVD's, etc.), among others, and transmission type media such as digital and analog communication links, including the Internet.

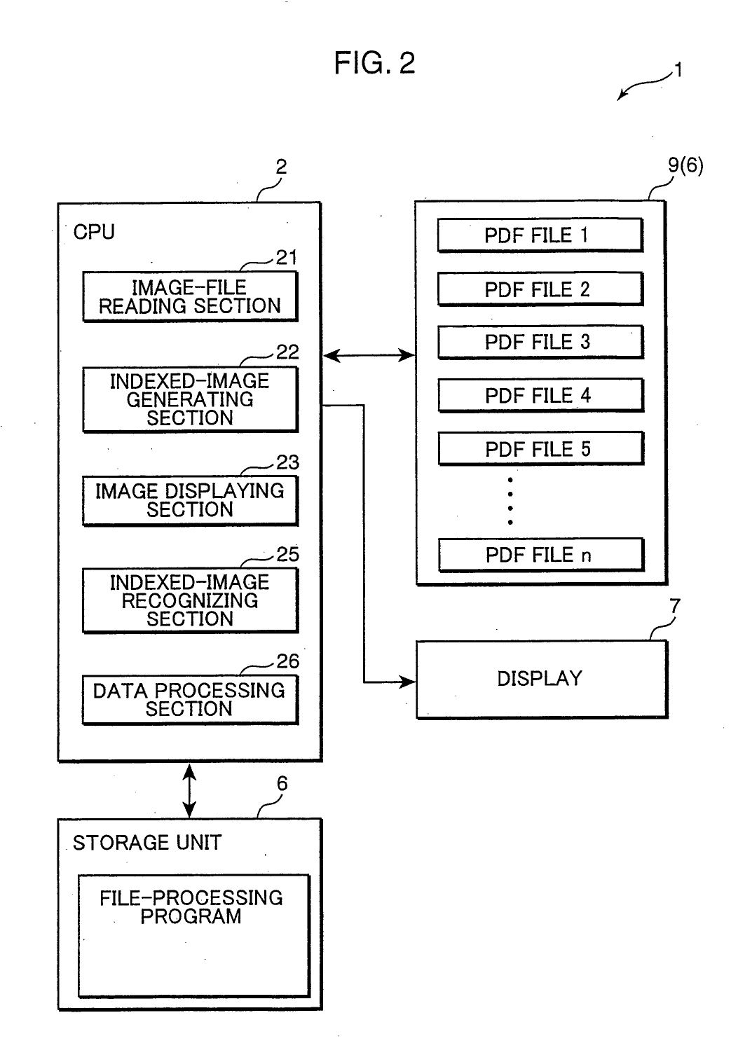

Next, main functions will be described of the personal computer 1 with the above described configuration. FIG. 2 is a block diagram showing main functions of the personal computer 1. As shown in FIG. 2, in the personal computer 1, the CPU 2 functions as a program-executing section according to the file processing program stored in the storage unit 6. The CPU 2 reads PDF files 1 to n containing one or more image data from the record medium 9 such as a CD-ROM in which those PDF files are stored, via the record-medium reading unit 8. Herein, the PDF files may also be stored in the storage unit 6. The CPU 2 generates an indexed image which displays the contents of the PDF files read from the record medium 9 or the storage unit 6. Then, the generated indexed image is transferred for the present to the RAM 5 which functions as an image memory and is displayed on the display 7.

The CPU 2 functions as: an image-file reading section (image-file reading means) 21 for reading the PDF files recorded on the record medium 9 based on a command given by the file processing program inside the storage unit 6; an indexed-image generating section (indexed-image generating means) 22 for generating an indexed image to be obtained by shrinking in size and displaying the content of an image data inside the PDF files; an image displaying section (image displaying means) 23 for displaying the generated indexed image on the screen of the display 7 via the RAM 5; an indexed-image recognizing section (indexed-image recognizing means, page-order replacement accepting means) 25 for recognizing that a desired indexed image has been selected out of the indexed images on the screen of the display 7 by a mouse-pointer operation or the like by the user; and a data processing section (processing means) 26 for generating a new PDF file by copying, deleting and rewriting a header, an object, a cross-reference section and a trailer which configure the PDF file, based on the content recognized by the indexed-image recognizing section 25.

Herein, the personal computer 1 having the function of executing such file processing as mentioned above can also be used as an image processing apparatus for file processing.

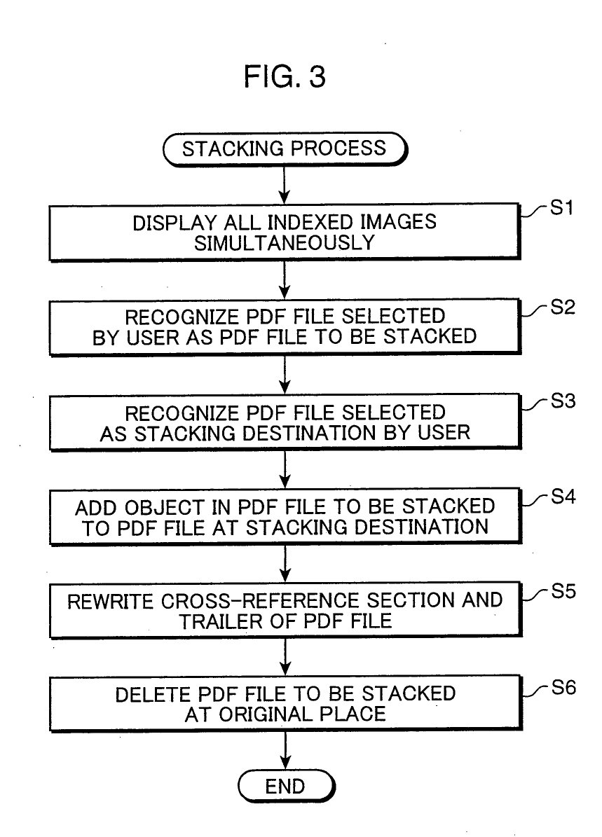

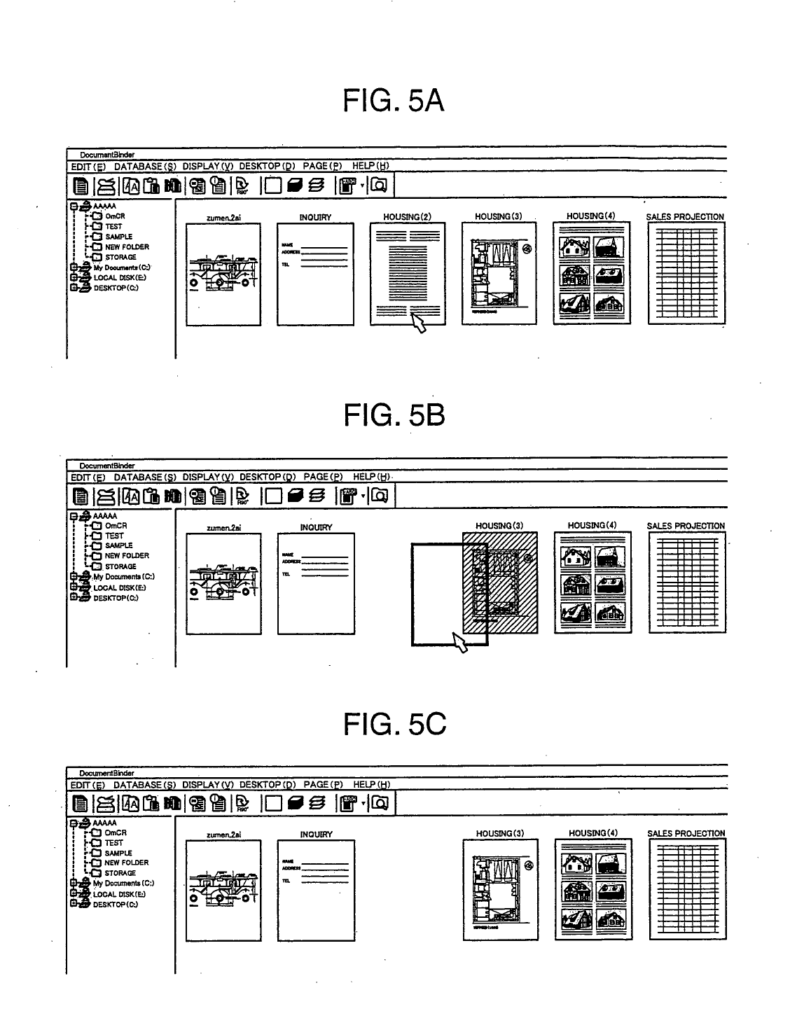

Next, a stacking process (or combining process) for the PDF files will be described, which is executed in accordance with the processing program. Referring to FIGS. 3 4A-4B, and 5A to 5C, the stacking process (or combining process) is a process for combining a plurality of PDF files into one file. Specifically, it is a process for adding an image data inside a PDF file (i.e., a PDF file to be stacked) to another PDF file on which the former PDF file is stacked as a new page of an image data and then deleting the former PDF file remaining at its original place. As shown in FIG. 5A, the indexed image of each PDF file (i.e., the first page of an image data included in each PDF file) stored on the record medium 9 is simultaneously displayed on the display 7 (S1). In this state, if the user selects a desired PDF file by an operation such as left-clicking of a mouse pointer (used as an example of a pointer) on a desired indexed image, the selected PDF file is recognized as a PDF file to be stacked (S2). Herein, the selected indexed image is displayed in a thick-line frame (FIG. 5A).

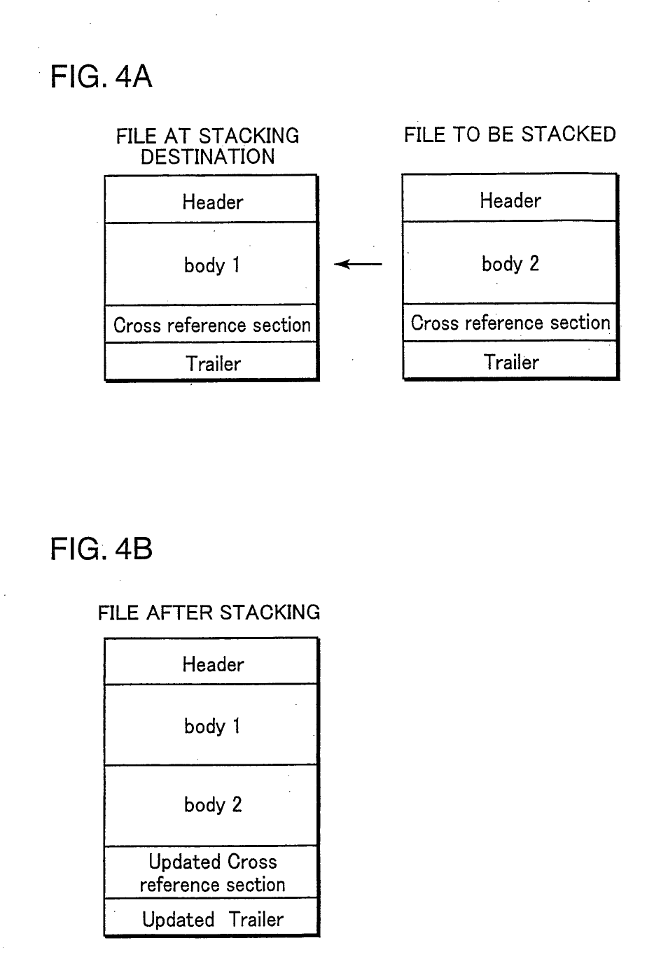

Then, if the user moves the selected indexed image onto another indexed image by an operation such as what is called dragging and dropping, the PDF file which corresponds to another indexed image is recognized as a PDF file at the place to which the selected indexed image has been moved (S3). Then, another indexed image is changed in color and displayed (FIG. 5B). After the image file at the stacking place has been recognized, a stacking process for this image file and the image file of the selected indexed image is executed. Herein, the PDF file at the stacking place is configured by a header (e.g., file information), an object (body 1, i.e., the portion of an image data or a document data), a cross-reference section (e.g., indexed information for managing a body) and a trailer (information for identifying the end of a file, including a control data or the like). In the stacking process, the object (body 2) included in the PDF file to be stacked which has been recognized at the step S2 is added to the PDF file at the stacking place (S4, FIG. 4A). Then, the cross-reference section and the trailer of the PDF file at the stacking place are rewritten into those having a content where the body 2 is added to the body 1 (S5, FIG. 4B), which is followed by the deletion of the PDF file to be stacked at its original place (S6).

In the PDF file after such a stacking process has been completed, the image data of the PDF file to be stacked which has been recognized at the step S1 is added to the PDF file at the stacking place which has been recognized at the step S3, as a new page of a image data. As shown in FIG. 5C, it is desirable that the indexed image of the PDF file after the stacking process should be displayed so that the user can recognize that the image data has been added.

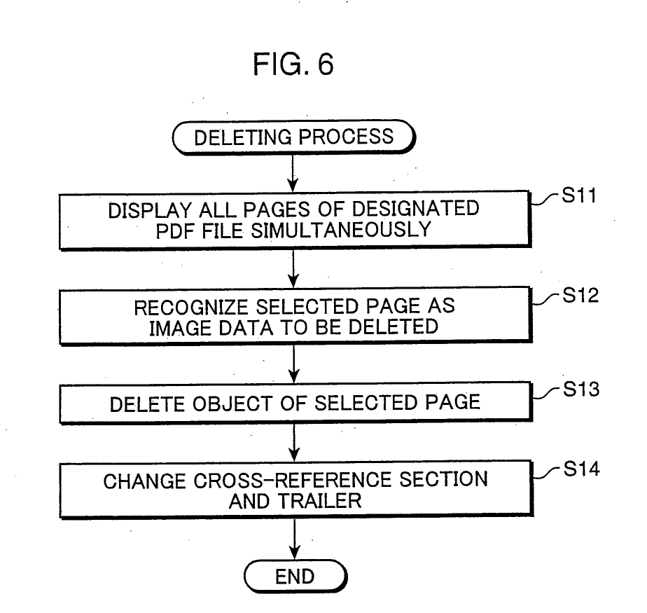

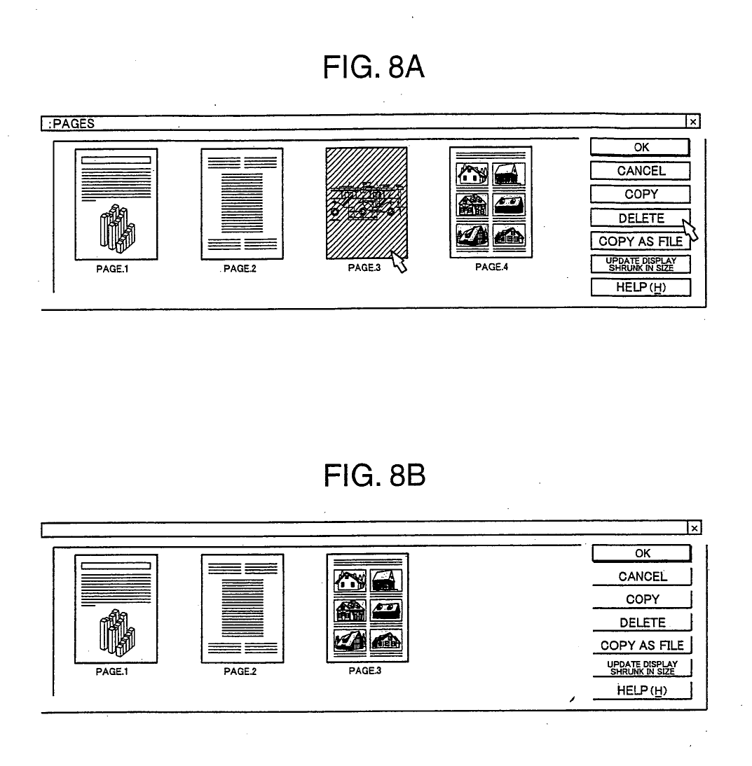

Next, a process will be described for deleting an image data included in a PDF file. Referring to FIGS. 6, 7A to 7B, and 8A to 8B, each page of an image data included in one PDF file is simultaneously displayed as an indexed image on the display 7 (S11). In this state, if the user selects the indexed image of the page the user wants to delete by an operation such as left-clicking of a mouse pointer on a desired page of an indexed image, the image data which corresponds to the indexed image is recognized as an image data to be deleted (S12). Then, the selected indexed image is changed in color and displayed (FIG. 8A).

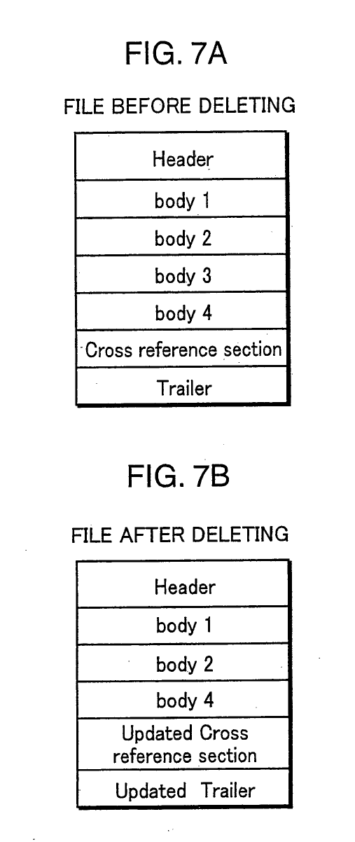

Next, a process for deleting an image data will be described, using a case where a PDF file includes the first to fourth pages and its third page is deleted. Herein, the PDF file is configured by a header, a body 1 (the first page of an image data), a body 2 (the second page of an image data), a body 3 (the third page of an image data), a body 4 (the fourth page of an image data), a cross-reference section and a trailer (FIG. 7A). The body 3 of the third page to be deleted is deleted (S13), and the cross-reference section and the trailer are rewritten so that their contents have only the bodies 1, 2 and 4 (S14, FIG. 7B). In the PDF file after such a deleting process has been completed, as shown in FIG. 8B, the indexed image of an image data which had been displayed as the third page before the deleting process is not displayed, and instead, the original fourth page is displayed as a new third page.

In such a deleting process, a PDF file is processed as follows. An object configuring the PDF file to be processed is deleted, and a cross-reference section and a trailer are rewritten in line with a new object after the processing. In other words, even when an image data inside a PDF file has been deleted, such a process as used conventionally is not executed. In the conventional process, the image data which has been deleted, and the cross-reference section and the trailer before the image data is deleted, are left, and a cross-reference section and a trailer having a content in which the image data is treated as having been deleted, are added further. Thereby, the image data which has been deleted is sure to be erased without being left in the PDF file after the processing. This can make the quantity of data in the PDF file after processing smaller. In addition, the cross-reference section and the trailer before processing are not left, allowing the quantity of data after processing to become smaller even in the cross-reference section and the trailer.

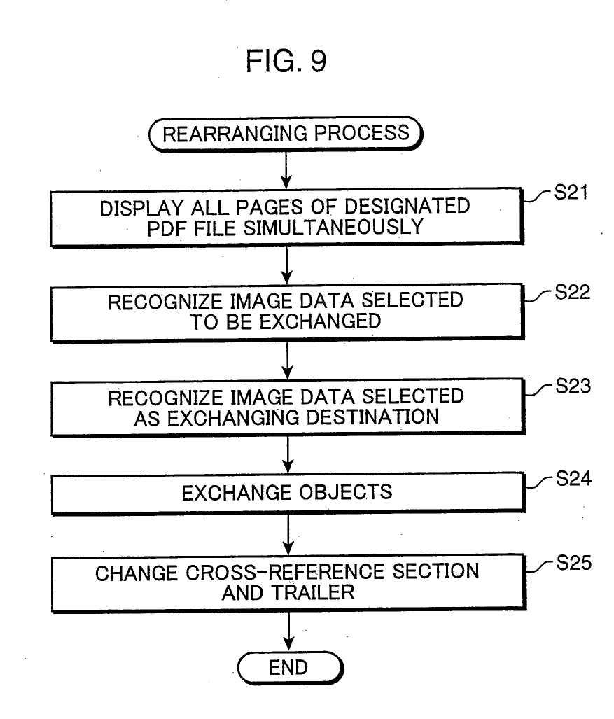

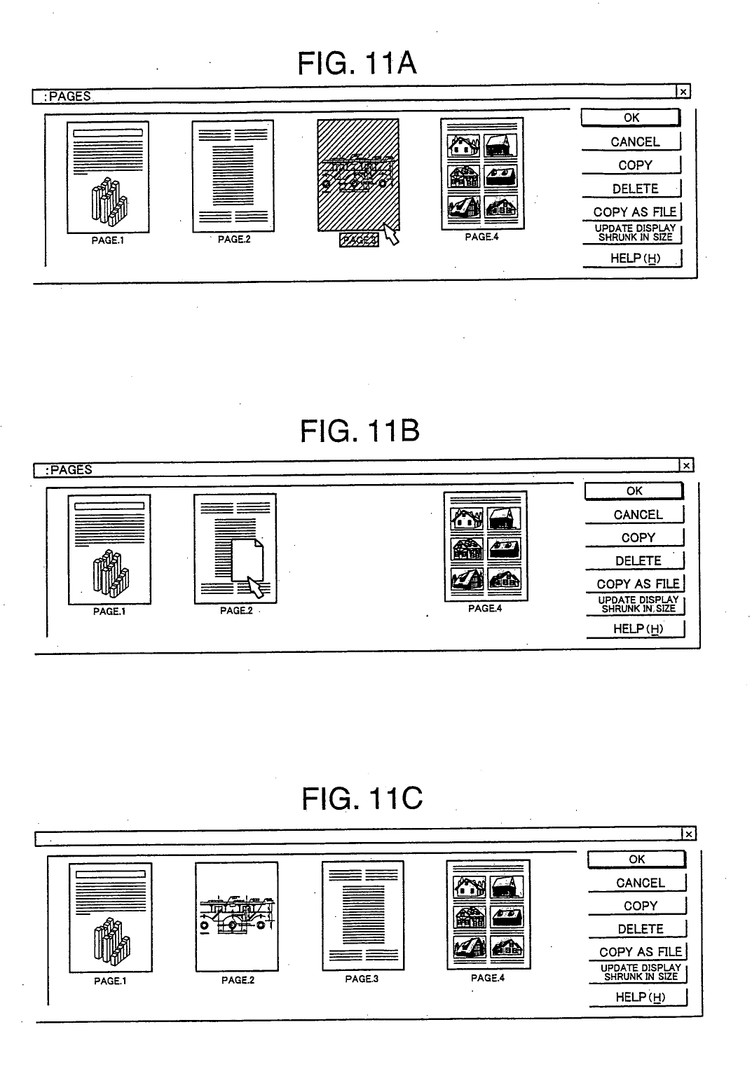

Next, a process will be described for replacing the order of page numbers of an image data included in a PDF file. Referring to FIGS. 9, 10A to 10B, and 11A to 11C, each page of an image data included in one PDF fi-le is simultaneously displayed as an indexed image on the display 7 (S21). In this state, if the user selects the indexed image of which the user wants to replace the page order by an operation such as left-clicking of a mouse pointer on a desired page of an indexed image, the image data which corresponds to the selected indexed image is recognized as an image data to be replaced (S22). Then, the selected indexed image is changed in color and displayed (FIG. 11A).

Next, if the user moves the selected indexed image onto another indexed image by an operation such as what is called dragging and dropping, the image data which corresponds to another indexed image is recognized as an image data at the place where the page order is replaced (S23). When the indexed image selected at the step S22 has been moved onto another indexed image, for example, its display turns into a display shown in FIG. 11B.

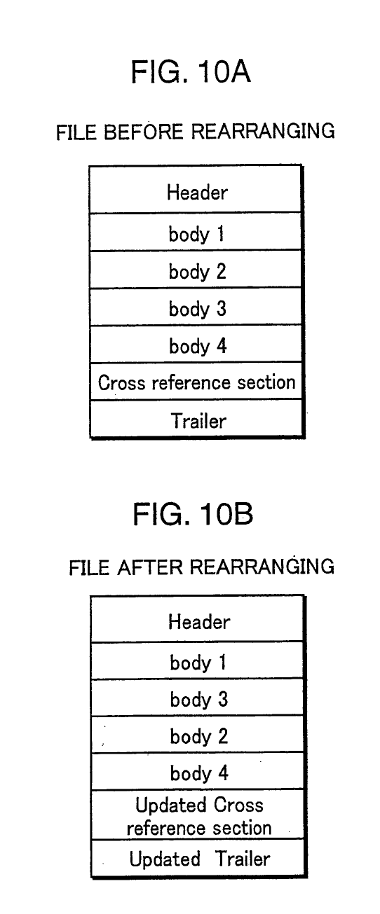

In the page-order replacing process for an image data, for example, as shown in FIGS. 11A and 11B, in the case where the second and third pages are exchanged, the array where bodies 1, 2, 3 and 4 are arranged in numerical order inside the PDF file (FIGS. 10A) is replaced with an array where bodies 1, 3, 2 and 4 are arranged in this order (S24). The replacing process is executed, for example, by copying (adding) and deleting each image data (body) at the same time. Then, the contents of a cross-reference section and a trailer are rewritten into contents showing the array of those bodies has become the order of bodies 1, 3, 2 and 4 (S25, FIGS. 10B). The pages of a PDF file after such a page-order replacing process has been completed are simultaneously displayed, as shown in FIG. 11C, by making the original third page of an indexed image a second page and the original second page of an indexed image a third page.

In this embodiment, if the user selects a plurality of desired indexed images out of the indexed images displayed on the screen of the display 7, the PDF files which correspond to the selected indexed images can be stacked, as well as deletion and page-order replacement of an image data included in a PDF file can be executed. This makes a difference between the present invention and any conventional ones. The user has no trouble processing PDF files, specifically the user does not need to enter their file names and the page number or the like of an image data to be deleted or replaced. Accordingly, the user can process PDF files by a mouse operation or another easy operation.

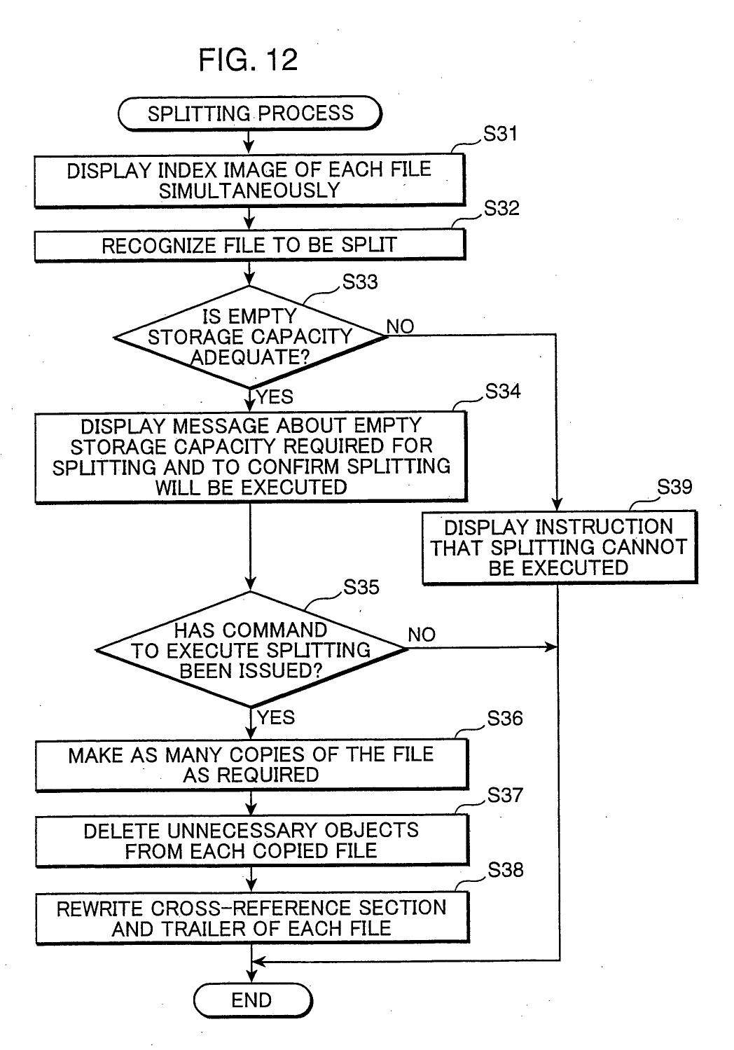

Next will be described a process for splitting a PDF file in accordance with the file-processing program with reference to FIGS. 12 to 16. The splitting process is a process for generating a new file by splitting a PDF file into each image data in the case where several pages of an image data are included in the PDF file. The splitting process may also include a process for extracting an image data inside a PDF file and generating a new separate file which includes the extracted image data.

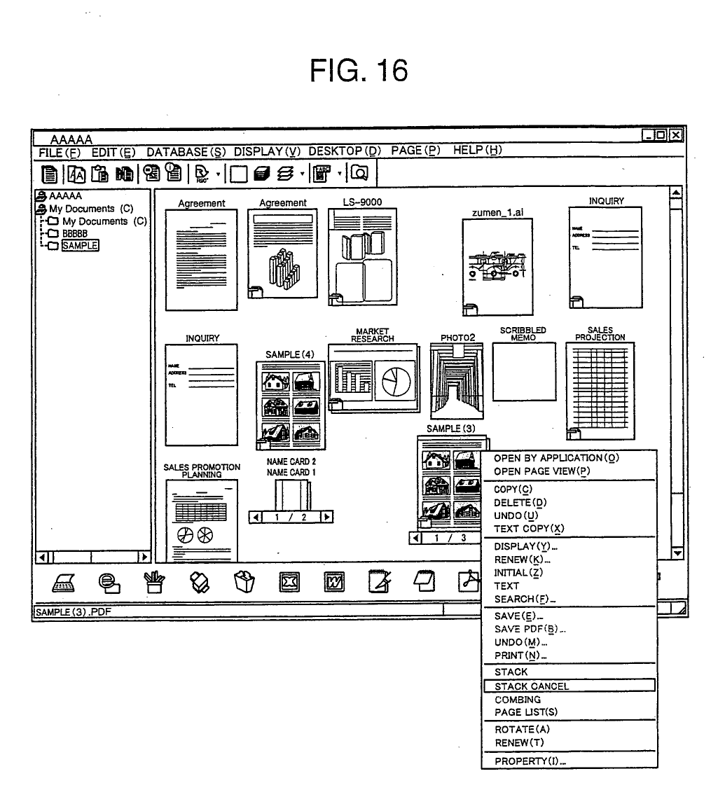

As shown in FIG. 5A, the indexed images of a PDF file (i.e., the first page of an image data included in the PDF file) stored on the record medium 9 are simultaneously displayed on the display 7 (S31). In this state, if the user selects the PDF file that the user attempts to split by an operation with a mouse pointer (used as an example of a pointer) or the like on a desired indexed image, as shown in FIG. 16, each item on a menu is displayed on the display 7. If “stack cancellation” (splitting process) is commanded on the menu, the selected PDF file is recognized as the PDF file to be split (S32).

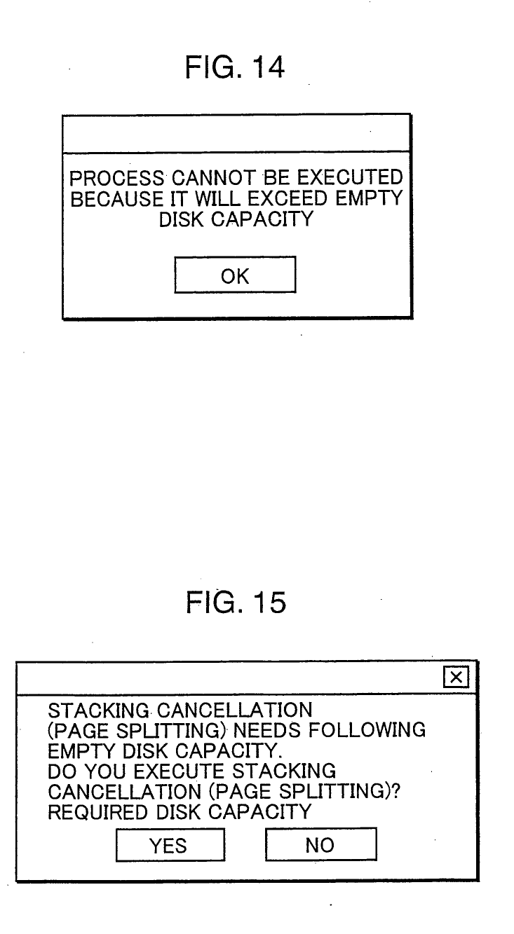

Then, the work area required for splitting the PDF file is compared with an empty storage capacity (S33). If the empty storage capacity is going to fall short (“NO” at the step S33), an instruction (see FIG. 14) is displayed that the splitting process cannot be executed (S39). On the other hand, if the empty storage capacity is not going to fall short (“YES” at the step S33), for example, as shown in FIG. 15, a message is displayed on the screen of the display 7, about the empty storage capacity required for the splitting process and to confirm that the splitting process will be executed, or about the increase of data amount after the splitting (S34).

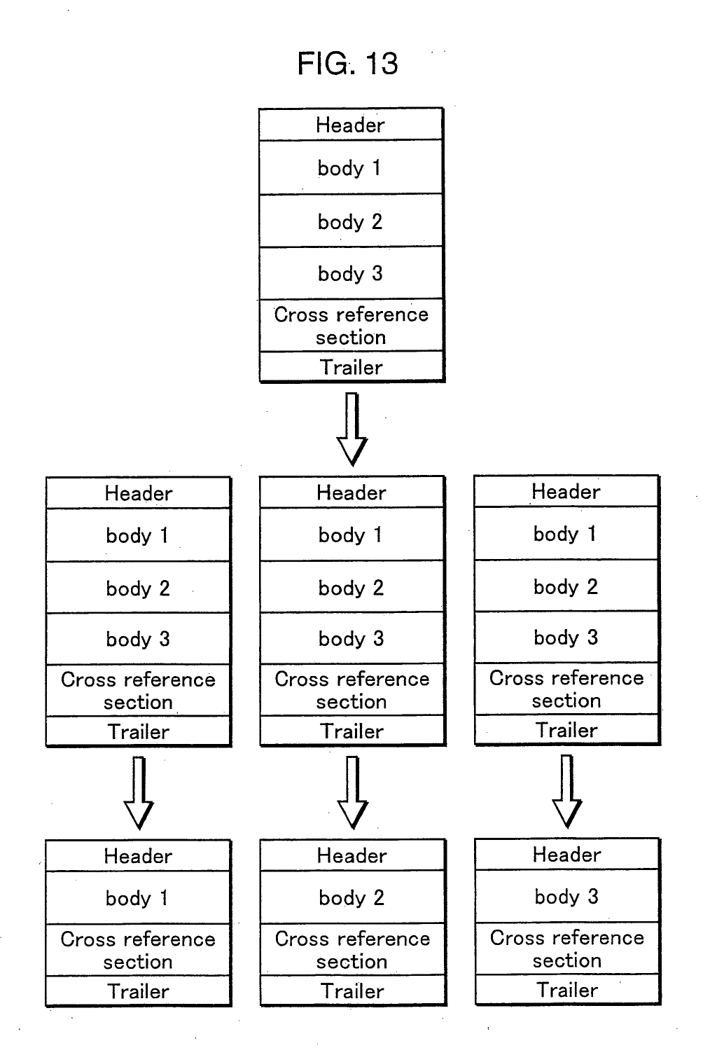

After this display at the step S34, if the user gives an instruction to execute the splitting process (“YES” at the step S35), copies of the PDF file to be split are made as many as required for the splitting process (S36). Specifically, as shown in FIG. 13, copied files of the PDF file are generated which are fewer by one than the image data (bodies) included in the PDF file. Herein, the PDF file is configured by a header (e.g., file information), an object (body, i.e., the portion of an image data or a document data), a cross-reference section (e.g., indexed information for managing a body) and a trailer (information for identifying the end of a file, including a control data or the like). Then, unnecessary objects (bodies) are deleted from each file (S37). In other words, except for the objects which the user wants to leave as the image data of new PDF files after the splitting, every object is deleted.

After the unnecessary objects of each PDF file have been deleted, the cross-reference section and the trailer of each file are rewritten into those having a content which shows an new object left after the deletion (S38). This completes the splitting process.

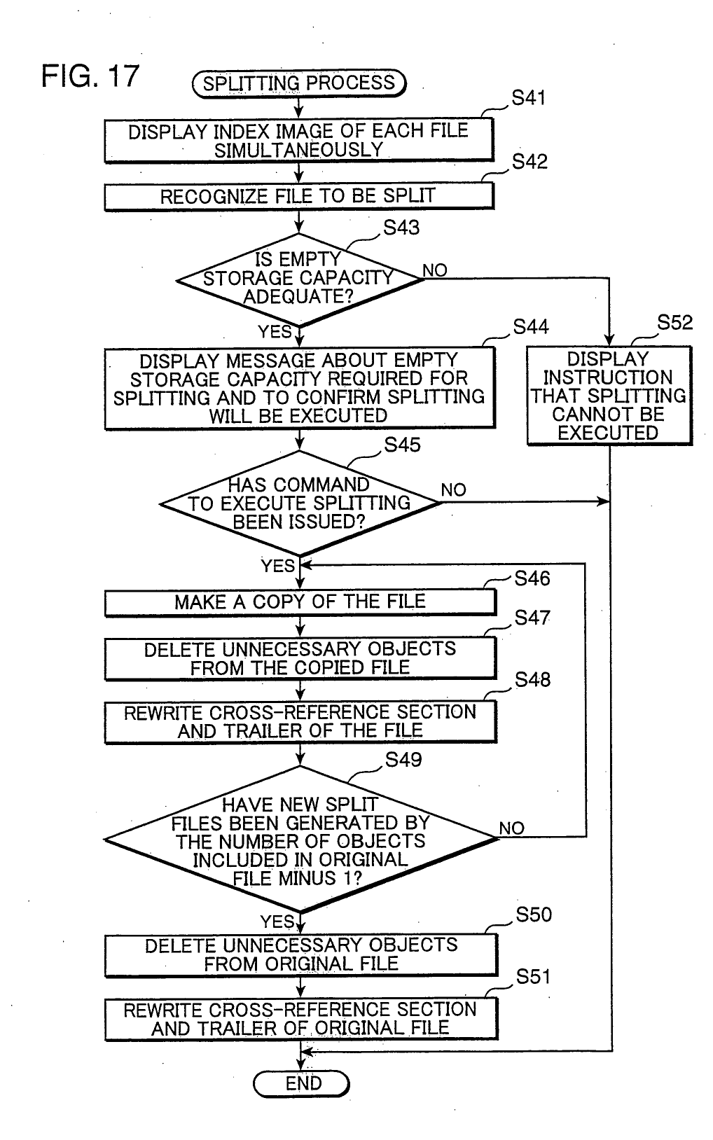

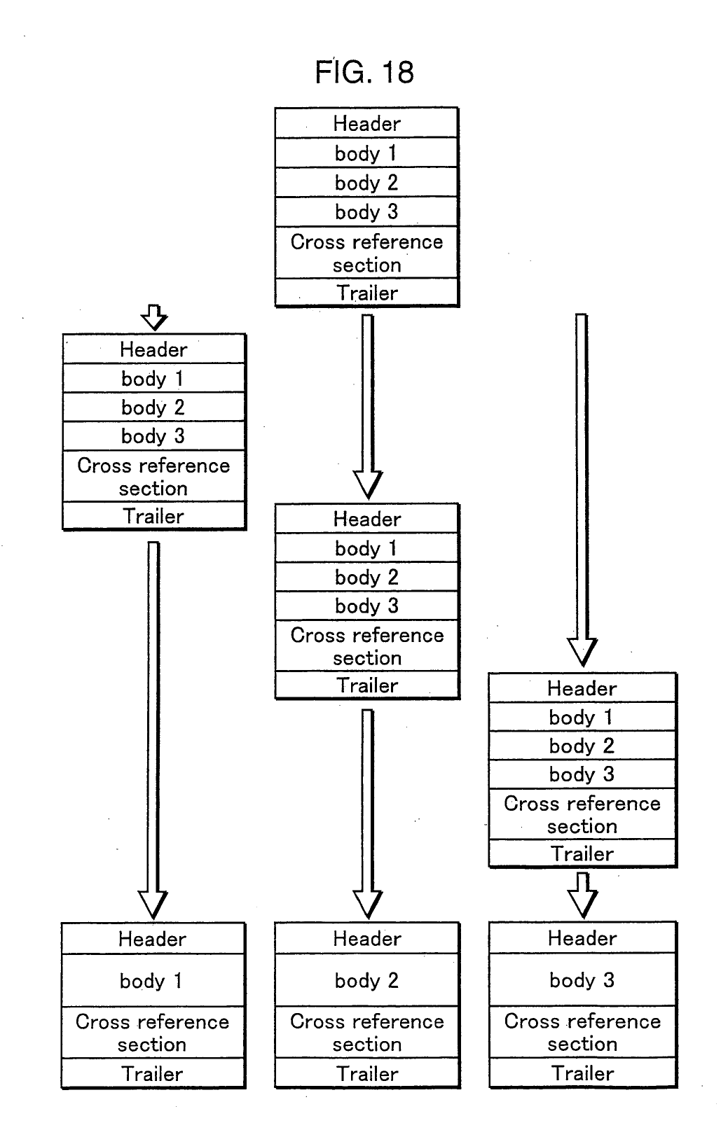

Next, another process for splitting a PDF file will be described with reference to FIGS. 17 and 18. In the previous process for splitting a PDF file, as many copies of the file as required for the splitting process are made at a time, and the deletion of objects of each copied file and the change of the cross-reference section and the trailer thereof are simultaneously executed (see the steps 36 to 38 in FIG. 12). In the second splitting process, however, newly-formed split files are generated one by one. In other words, the process for generating one split file has been completed, and thereafter, the process for generating another split file starts (see steps 46 to 51 in FIG. 17).

Specifically, if the user gives an instruction to execute the splitting process (“YES” at a step S45), only one copy of the PDF file to be split are made (S46), unnecessary objects after the splitting are deleted from the copied file (S47), and the cross-reference section and the trailer of the file are rewritten into those having a content which shows an new object left after the deletion (S48). This process at the steps S46 to 48 is repeated until new split files are generated which are fewer by one than the objects included in the original PDF file (S49).

When new split files have been generated which are fewer by one than the objects included in the original PDF file (“YES” at the step S49), the original PDF file itself is processed. The objects unnecessary after the splitting are deleted from the original PDF file (S50), and the cross-reference section and the trailer of the original PDF file are rewritten into those having a content which shows an object after the deletion (S51). This completes the splitting process.

In the step S49, new split files are generated which are fewer by one than the objects included in the original PDF file, and finally, the original PDF file itself is processed. Instead of such a process, however, it may be possible to generate as many new split files as the objects of the original PDF file and then delete the original file.

In the second splitting process, a plurality of copied files are not generated all at once from the original PDF file. As shown in FIG. 18, one copied file is subject to object deletion or the like, reducing the quantity of its data. Thereafter, new split files start to be generated. This will not require a large work area for file copying, different from the splitting process shown in FIG. 4. Therefore, when the empty storage capacity of a computer is confirmed at the step S43 before the splitting process is executed in the second splitting process, a judgment that the splitting process can be executed is made even though the computer has a smaller empty storage capacity than that in the first splitting process.

The present invention is not limited to the configuration of the above described embodiments and can be applied to many variations. For example, the first splitting process may also be combined with the second splitting process, responding to the storage capacity which is confirmed before the splitting process is executed. In detail, if there is an empty storage capacity adequate to execute the first splitting process, then this splitting process is executed (in which as many copies of the file as required for the splitting process are made at a time, and the deletion of objects of each copied file and the change of the cross-reference section and the trailer thereof are simultaneously executed). On the other hand, if there is not an empty storage capacity adequate to execute the first splitting process, then the first splitting process is executed (in which new split files are generated one by one and the process for generating one split file is followed by the process for generating another split file). This can benefit the process for generating a plurality of split files. Specifically, if there is an enough empty storage capacity, several split files are simultaneously generated, shortening the time spent for such a process. If not, several split files are generated one by one, keeping any heavy load from being borne on a computer and also preventing a hang-up and other malfunctions.

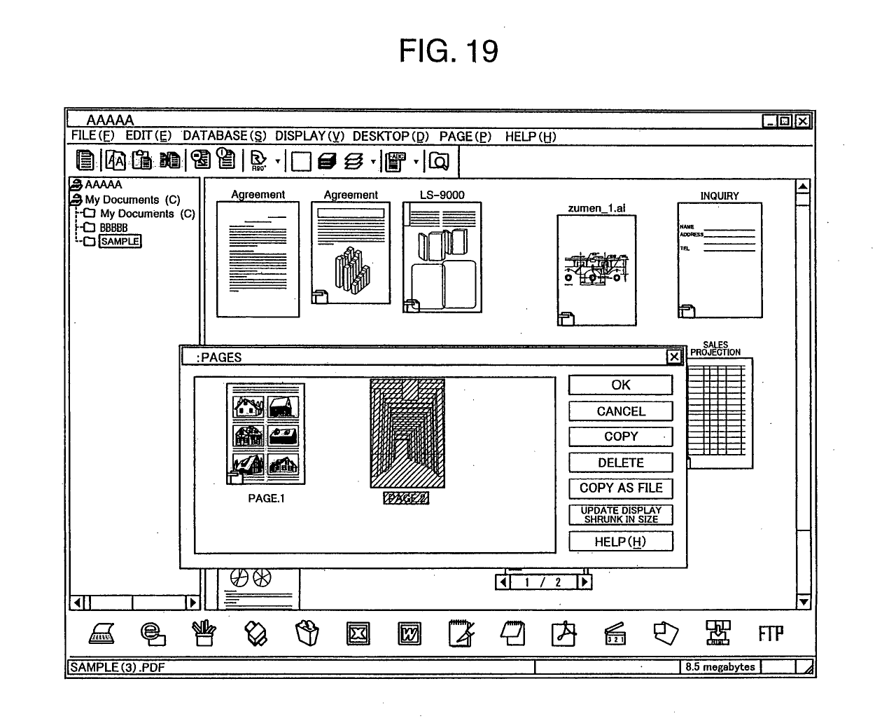

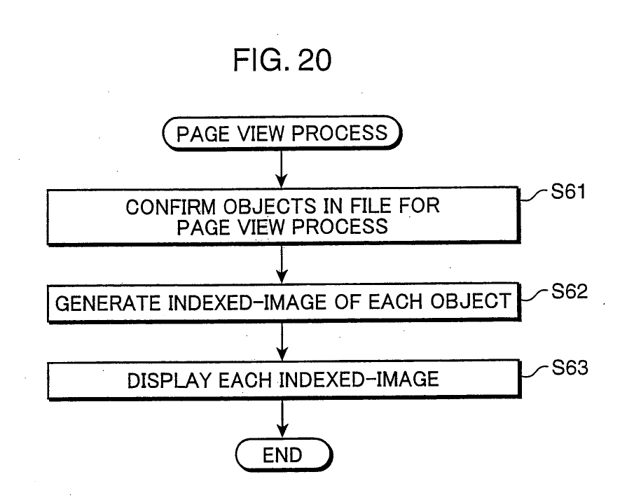

In the splitting processes according to the above described embodiment, the indexed-images corresponding to the respective PDF files are simultaneously displayed on the display 7. As shown in FIG. 19, however, it may be appreciated to display listed image data included in each page of a PDF file as page view display. In this case, when the indexed-images of the respective PDF files are displayed on the display 7, a particular PDF file is selected by the user's mouse pointer operation or the like to thereby display the menu shown in FIG. 16 on the display 7. If the user selects the “Open Page-View” from the menu, the page view process is executed. Referring to FIG. 20 showing a process for displaying a view of a particular page, if the “Open Page-View” is selected, at step S61, it is executed to confirm image data or object of each page included in the selected PDF file. An indexed-image of objects is generated at step S62, and generated indexed-images are simultaneously displayed on the display 7 at step S63.

Further, it may be appreciated that when the user selects a desired indexed image (PDF file) in the state where the image data of each page included in the particular PDF file are simultaneously displayed on the display 7 as shown in FIG. 19, image data corresponding to the selected indexed-image is extracted from the particular PDF file, and is then generated as a new PDF file. The generation of such new PDF file is executed in a similar way as the process shown in FIGS. 12 and 17. Specifically, a copy of the original PDF file is made. A new PDF file is generated by deleting the objects other than a targeted object from the copied PDF file while the targeted object is deleted from the original PDF file. Thereafter, the cross reference sections and the trailers of the original and new PDF files are respectively rewritten to indicate the new information.

In the above described embodiments, a PDF file is used as the file to be processed in the file-processing method, but other types of files can also be used as such a file.

In the above described embodiments, the PDF file to be processed or an image data inside a PDF file is selected by an operation such as dragging and dropping of a mouse pointer, but such a selecting operation may also be made using a keyboard or another pointer.

As described above, a program product for processing a file, comprising a program configured to cause a computer to function as: file reading means for reading a file recorded on a record medium; indexed-image generating means for generating an indexed image on the basis of the file; image displaying means for displaying the indexed image generated by the indexed-image generator on a display screen; and processing means for processing a file by way of the displayed indexed-image; and a signal bearing medium bearing the program.

It may be preferable that the indexed-image generating means generates an indexed image of the read file on the basis of the file; and the processing means includes: indexed-image recognizing means for recognizing that a plurality of indexed images are selected out of the indexed images displayed on the display screen by the image displaying means; and combining means for combining files corresponding to the plurality of indexed images recognized by the indexed-image recognizing means into a single file.

Also, it may be preferable that the indexed-image generating means generates an indexed image of image data included in the read file each page; the image displaying means displays the indexed image generated by the indexed-image generating means in order of page numbers on the display screen; the processing means includes: a page-order replacement accepting means for accepting two indexed images corresponding to image data targeted for replacing the page order by designating indexed images displayed on the display screen by the image displaying means; and replacing means for replacing the page order of the image data when the two indexed images are accepted by the page-order replacement accepting means.

Further, it may be preferable that the indexed-image generating means for generating an indexed image of image data included in the read file each page; the image displaying means displays the indexed image generated by the indexed-image generating means in order of page numbers on the display screen; the processing means includes: an indexed-image recognizing means for recognizing that one or a plurality of indexed images are selected out of indexed images displayed on the display screen by the image displaying means; and deleting means for deleting image data which corresponds to the indexed image recognized by the indexed-image recognizing means.

Furthermore, it may be preferable that the indexed-image generating means generates an indexed image of the file read by the file reading means; the processing means includes: indexed-image recognizing means for recognizing that a desired indexed image is selected out of indexed images displayed on the display screen by the image displaying means; and generating means for generating new files by splitting an original file which corresponds to the indexed image recognized by the indexed-image recognizing means each image data included in the original file.

Preferably, moreover, the file may be configured by a header, an object, a cross-reference section and a trailer. In this case, the processing means may process the file by processing the object included in a file to be processed and rewriting the cross-reference section and the trailer in line with a new object after the processing.

Alternatively, the processing means may generate a new file by copying the file, deleting an unnecessary object from the copied file and rewriting the cross-reference section and the trailer into a content corresponding to an object after the deletion. Further, the processing means may generate one new file by generating a copied file from an original file, deleting an unnecessary object from the copied file and rewriting the cross-reference section and the trailer, and generates another new file by copying the original file further. Moreover, the processing means may execute the file-splitting in which the generation another new split file follows the generation of the one new file in the case where the empty storage capacity of the computer is small, and the processing means makes as many copies of the file as required for the splitting at once and simultaneously executes the deleting of the object and the changing of the cross-reference section and the trailer with respect to each copied file in the case where the empty storage capacity of a computer is large.

The image displaying means may display a message that the quantity of data will increase after the file-splitting has been executed, on a display screen, before the file-splitting is executed.

The file-splitting may be preferably executed only in the case where the user directs the file-splitting to be executed, after a message that the quantity of data will increase after the file-splitting has been executed is displayed on the display screen.

An inventive file processing apparatus, comprises: a file reader which reads a file recorded on a record medium; an indexed-image generator which generates an indexed image on the basis of the file; an image display device which displays the indexed image generated by the indexed-image generator on a display screen; and a processor which processes a file by way of the displayed indexed-image.

An inventive file processing method comprises the steps of: reading a file recorded on a record medium; generating an indexed image on the basis of the file; displaying the generated indexed image on a display screen; and processing a file by way of the displayed indexed-image.

With these construction, if the user selects a plurality of desired indexed images out of indexed images displayed on the display screen, the files which correspond to the selected indexed images are combined into one file. Thereby, the user has no trouble combining those files, specifically the user does not need to enter their file names. Accordingly, the user can combine a plurality of files into one by an easy operation (e.g., a mouse operation) only based on information displayed on the display screen.

Also, if you designate two indexed images displayed on the display screen, then the page order of the two indexed images will be changed. Thereby, you can replace the page order of an image data in a file, without entering values according to which page you want to exchange for which page in the file, or the like. As a result, there will be no need for the user to be aware of the page order of an image data in a file, or the like. The user can replace the page order of an image data, only by making an easy operation based on information (or indexed images) displayed at the image display.

Further, if you designate, on the display screen, the indexed images you want to delete from the indexed images displayed on the display screen, then the image data in the file corresponding to the designated indexed images will be deleted. Thereby, you can delete the image data in the file, without entering values according to which page the image data you want to delete is, or the like. As a result, there will be no need for the user to be aware of the page order of an image data in a file, or the like. The user can delete an image data, only by making an easy operation based on information (or indexed images) displayed at the image display.

Moreover, the object which configures a file is deleted, the page order is changed, or the like, and the contents of the cross-reference section and the trailer are rewritten in line with a new object after the processing. In other words, even when an image data in a file has been deleted or processed otherwise, it can be eliminated to execute the process as used conventionally. In the conventional process, the image data which has been deleted or processed otherwise, and the cross-reference section and the trailer before the image data is deleted or processed otherwise, are still left, and a cross-reference section and a trailer having a content in which the image data is treated as having been deleted, are added further. The image data to be deleted is sure to be erased without being left in the file after the processing. This can make the quantity of file data after processing smaller. In addition, the cross-reference section and the trailer before processing are not left in the file, allowing the quantity of data after processing to become smaller even in the cross-reference section and the trailer.

If the user selects desired indexed images out of the indexed images displayed on the display screen, the image data which corresponds to the selected indexed images is split from the file and is generated as a new separate file. Thereby, there will be no need for the user to be aware of the page order of an image data in a file, or the like. The user can split an image data in a file and generate a new separate file, only by making an easy operation (e.g., a mouse-pointer operation) based on information (or indexed images) displayed at the image display step.

Moreover, after the splitting, an unnecessary object is erased and is not left in the new file. In addition, the cross-reference section and the trailer are rewritten in line with a new object after the processing, and the cross-reference section and the trailer before processing are not left in the new file. As a result, even though one file is split into several files, the quantity of data which increases after the splitting becomes extremely small.

During the process for splitting a file, also, after one new file has been generated, another new file starts to be generated. In other words, several copied files are not generated at a time, or the splitting process is not executed for several files side by side. This will not require a computer to have a large quantity of empty storage capacity while the file splitting process is being executed. As a result, the load borne on the computer is lightened, preventing a hang-up and other malfunctions.

Furthermore, in the case where the empty storage capacity of a computer is small, after the one new split file has been generated, another new split file starts to be generated. Thereby, the load borne on the computer is lightened, preventing a hang-up and other malfunctions. On the other hand, in the case where the empty storage capacity of a computer is large, several copied files are generated at a time, and deletion of the object and rewriting of the cross-reference section and the trailer are simultaneously executed with respect to each copied file. This enables a splitting process to be completed within a short period of time.

The user is notified by the message that the quantity of data will increase after the processing means has executed the file-splitting process, on a display screen, before the file-splitting process. Thereby, the user can get the idea in advance that the total quantity of data in each file after the splitting will become larger than that before the splitting. This will keep a computer from falling short of its storage capacity in the file-splitting process. As a result, a hang-up or an abnormal termination of the computer can be prevented beforehand from occurring.

Moreover, after the message that the quantity of file data will increase after the file-splitting process is displayed, the file-splitting process is executed only when the user issues the command for the file-splitting process to be executed. This can prevent, more certainly, a hang-up or an abnormal termination of a computer from taking place.

This application is based on patent application Nos. 2002-244209 and 2002-244210 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

1. A program product for processing a file, comprising:
a program configured to cause a computer to function as:
file reading means for reading a file recorded on a record medium;
indexed-image generating means for generating an indexed image on the basis of the file;
image displaying means for displaying the indexed image generated by the indexed-image generating means on a display screen; and
processing means for processing a file by way of the displayed indexed-image; and
a signal bearing medium bearing the program.

2. A program product according to claim 1, wherein:
the indexed-image generating means generates an indexed image of the read file on the basis of the file; and
the processing means includes:
indexed-image recognizing means for recognizing that a plurality of indexed images are selected out of the indexed images displayed on the display screen by the image displaying means; and
combining means for combining files corresponding to the plurality of indexed images recognized by the indexed-image recognizing means into a single file.

3. A program product according to claim 1, wherein:
the indexed-image generating means generates an indexed image of image data included in the read file each page;
the image displaying means displays the indexed image generated by the indexed-image generating means in order of page numbers on the display screen;
the processing means includes:
a page-order replacement accepting means for accepting two indexed images corresponding to image data targeted for replacing the page order by designating indexed images displayed on the display screen by the image displaying means; and
replacing means for replacing the page order of the image data when the two indexed images are accepted by the page-order replacement accepting means.

4. A program product according to claim 1, wherein
the indexed-image generating means for generating an indexed image of image data included in the read file each page;
the image displaying means displays the indexed image generated by the indexed-image generating means in order of page numbers on the display screen;
the processing means includes:
an indexed-image recognizing means for recognizing that one or a plurality of indexed images are selected out of indexed images displayed on the display screen by the image displaying means; and
deleting means for deleting image data which corresponds to the indexed image recognized by the indexed-image recognizing means.

5. A program product according to claim 1, wherein:
the file is configured by a header, an object, a cross-reference section and a trailer; and
the processing means processes the file by processing the object included in a file to be processed and rewriting the cross-reference section and the trailer in line with a new object after the processing.

6. A program product according to claim 1, wherein
the indexed-image generating means generates an indexed image of the file read by the file reading means;
the processing means includes:
indexed-image recognizing means for recognizing that a desired indexed image is selected out of indexed images displayed on the display screen by the image displaying means; and
generating means for generating new files by splitting an original file which corresponds to the indexed image recognized by the indexed-image recognizing means each image data included in the original file.

7. A program product according to claim 6, wherein:
the file is configured by a header, an object, a cross-reference section and a trailer; and
the processing means generates a new file by copying the file, deleting an unnecessary object from the copied file and rewriting the cross-reference section and the trailer into a content corresponding to an object after the deletion.

8. A program product according to claim 7, wherein the processing means generates one new file by generating a copied file from an original file, deleting an unnecessary object from the copied file and rewriting the cross-reference section and the trailer, and generates another new file by copying the original file further.

9. A program product according to claim 8, wherein the processing means executes the file-splitting in which the generation another new split file follows the generation of the one new file in the case where the empty storage capacity of the computer is small, and the processing means makes as many copies of the file as required for the splitting at once and simultaneously executes the deleting of the object and the changing of the cross-reference section and the trailer with respect to each copied file in the case where the empty storage capacity of a computer is large.

10. A program product according to claim 7, wherein the image displaying means displays a message that the quantity of data will increase after the file-splitting has been executed, on a display screen, before the file-splitting is executed.

11. A program product according to claim 10, wherein the file-splitting is executed only in the case where the user directs the file-splitting to be executed, after a message that the quantity of data will increase after the file-splitting has been executed is displayed on the display screen.

12. A file processing apparatus, comprising:
a file reader which reads a file recorded on a record medium;
an indexed-image generator which generates an indexed image on the basis of the file;
an image display device which displays the indexed image generated by the indexed-image generator on a display screen; and
a processor which processes a file by way of the displayed indexed-image.

13. A file processing apparatus according to claim 12, wherein:
the indexed-image generator generates an indexed image of the read file on the basis of the file; and
the processor includes:
an indexed-image recognizer which recognizes that a plurality of indexed images are selected out of the indexed images displayed on the display screen by the image displaying device; and
a combining device which combines files corresponding to the plurality of indexed images recognized by the indexed-image recognizer into a single file.

14. A file processing apparatus according to claim 12, wherein:
the indexed-image generator generates an indexed image of image data included in the read file each page;
the image displaying device displays the indexed image generated by the indexed-image generator in order of page numbers on the display screen;
the processor includes:
a page-order replacement accepting devices which accepts two indexed images corresponding to image data targeted for replacing the page order by designating indexed images displayed on the display screen by the image displaying device; and
a replacing device which replaces the page order of the image data when the two indexed images are accepted by the page-order replacement accepting device.

15. A file processing apparatus according to claim 12, wherein
the indexed-image generator generates an indexed image of image data included in the read file each page;
the image displaying device displays the indexed image generated by the indexed-image generator in order of page numbers on the display screen;
the processor includes:
an indexed-image recognizer which recognizes that one or a plurality of indexed images are selected out of indexed images displayed on the display screen by the image displaying device; and
a deleting device which deletes image data corresponding to the indexed image recognized by the indexed-image recognizing device.

16. A file processing apparatus according to claim 12, wherein
the indexed-image generator generates an indexed image of the file read by the file reader;
the processor includes:
an indexed-image recognizer which recognizes that a desired indexed image is selected out of indexed images displayed on the display screen by the image displaying device; and
a new file generator which generates new files by splitting an original file which corresponds to the indexed image recognized by the indexed-image recognizer each image data included in the original file.

17. A file processing method comprising the steps of:
reading a file recorded on a record medium;
generating an indexed image on the basis of the file;
displaying the generated indexed image on a display screen; and
processing a file by way of the displayed indexed-image.

18. A file processing method according to claim 17, wherein:
the indexed image is generated on the basis of the read file; and
the processing step includes the sub-steps of:
recognizing that a plurality of indexed images are selected out of the indexed images displayed on the display screen; and
combining files corresponding to the plurality of recognized indexed images into a single file.

19. A file processing method according to claim 17, wherein:
an indexed image of image data included in the read file each page is generated at the indexed image generating step;
the generated indexed image is displayed in order of page numbers on the display screen;
the processing step includes the sub-steps of:
accepting two indexed images corresponding to image data targeted for replacing the page order by designating indexed images displayed on the display screen; and
replacing the page order of the image data when the two indexed images are accepted.

20. A file processing method according to claim 17, wherein
an indexed image of image data included in the read file each page is generated at the indexed image generating step;
the generated indexed image is displayed in order of page numbers on the display screen;
the processing step includes the sub-steps of:
recognizing that one or a plurality of indexed images are selected out of indexed images displayed on the display screen; and
deleting image data which corresponds to the recognized indexed image.

21. A file processing method according to claim 17, wherein
an indexed image of the read file is generated in the indexed image generating step;
the processing step includes the sub-steps of:
recognizing that a desired indexed image is selected out of indexed images displayed on the display screen; and
generating new files by splitting an original file which corresponds to the recognized indexed image each image data included in the original file.
